(19) United States
(12) Patent Application Publication
(10) Pub. No.: US 2017/0201542 A1
(43) Pub. Date: Jul. 13, 2017

(54) ABNORMAL BEHAVIOR DETECTION SYSTEM CONSIDERING ERROR RATE DEVIATION OF ENTIRE USE BEHAVIOR PATTERN DURING PERSONALIZED CONNECTION PERIOD

(71) Applicant: KOREA INTERNET & SECURITY AGENCY, Seoul (KR)

(72) Inventors: Hwan Kuk Kim, Seoul (KR); Tae Eun Kim, Anyang-si (KR); Chang Min Jo, Seoul (KR); Sa Rang Na, Seongnam-si (KR); Jee Soo Jurn, Seoul (KR)

(21) Appl. No.: 15/006,498

(22) Filed: Jan. 26, 2016

(30) Foreign Application Priority Data
Jan. 7, 2016 (KR) 10-2016-0002288

(51) Int. Cl. H04L 29/06

(52) U.S. Cl. CPC H04L 63/1425; H04L 63/1416

(57) ABSTRACT

Differently from the existing network-based security systems through network traffic analysis, the abnormal behavior detection system implemented a method for detecting an abnormal behavior by patterning various behavior elements, such as time, position, connection network and a used device of an object. In order to enhance system security in the BYOD and smart work environment, the abnormal behavior detection system processes situation information into situation information of connection, use and agent and profile information and detects behaviors, such as abnormal access and use of a terminal device using the entire use behavior pattern and deviation of pattern error rate during the personalized connection period.

### CROSS REFERENCE TO RELATED APPLICATION

The present application claims the benefit of Korean Patent Application No. 10-2016-0002288 filed in the Korean Intellectual Property Office on Jan. 7, 2016, the entire contents of which are incorporated herein by reference.

### BACKGROUND OF THE INVENTION

Field of the Invention

The present invention relates to a system for protecting internal resources in a BYOD (Bring Your Own Device) and smart work environment, and, more particularly, to an abnormal behavior detection system in a BYOD and smart work environment.

Background Art

Propagation of internet infra and development of mobile communication bring a significant change which is a revolution in society. Particularly, mobile devices like smart phones are very much ingrained into our lives beyond the meaning of simple communication means. Such a trend has spread to work places, and so, a new working environment by the name of BYOD (Bring Your Own Device) has appeared. The BYOD is a concept to utilize a personal device to work, namely, means all of technology, concept and policy to access to IT resources, such as databases, applications, within an enterprise using personal mobile devices, such as smart phones, lap-top computers, tablet PCs, and so on. From the point of view of enterprises, the BYOD may promote speed, efficiency and productivity of work through more effective business management and reduce financial burdens for supplying business machines because employees can utilize their own personal devices. Accordingly, many enterprises are considering how to successfully introduce the BYOD, and many users have been utilizing personal devices to their business before companies were prepared to apply the BYOD.

The BYOD and smart work environment which is a new IT environment has accelerated construction of wireless internet environment, generalization of smart devices, such as table PCs and smart phones, virtualization of desktop computers, increase of utilization of cloud services, and putting emphasis on business continuity with real-time communication and the likes.

Moreover, with the coming of the BYOD era, infrastructure of companies is being converted from closed environment to open environment. That is, access to enterprise infra by personal devices is authorized anywhere and at any time.

Personal devices can access to enterprise infra through a wireless router (AP), a switch or the like inside companies, and can access to enterprise infra through a mobile communication network, open Wi-Fi, VPN or the likes from the outside of enterprises.

As described above, such changes into open environment cause business continuity and convenience, but may cause lots of security threats that people never expected before. Above all things, due to access of personal devices to enterprise internal infra, internal data of enterprises is at a great risk of leakage. In other words, the internal data of enterprises may be leaked due to a loss or a robbery of the personal devices, and access of the personal devices infected by malicious code to the internal intranet of an enterprise may threaten IT assets of the enterprise.

In order to solve such problems, Korea Internet and Security Agency has implemented an abnormal behavior detection system using the entire use behavior pattern during a personalized connection period (Korean Patent Application No. 10-2015-0000989, hereinafter, called a ‘prior art’).

However, the prior art has a limit in calculating a normal range in the process of detecting a variation of the entire behavior item and a variation of an individual behavior item and deciding whether a user's use behavior is normal or not. Furthermore, the prior art is insufficient and ineffective in the process of deciding whether the user's use behavior is abnormal or not. So, people demand additional analysis algorithm which can compensate the defects of the prior arts and can enhance capacity for detecting an abnormal behavior.

Patent Document 1: Korean Patent Application No. 10-2015-0000989 entitled “Abnormal behavior detection system using entire use behavior pattern during personalized connection period”

### SUMMARY OF THE INVENTION

Accordingly, the present invention has been made to solve the above-mentioned problems occurring in the prior arts, and it is an object of the present invention to provide an abnormal behavior detection system which can process situation information of a BYOD and smart work environment, construct profiles by user and detect an abnormal behavior based on the processed situation information and constructed profiles in order to detect an abnormal access of a device and a real-time abnormal use behavior.

It is another object of the present invention to provide an abnormal behavior detection system for detecting an abnormal behavior using a first analysis, which analyzes behavior frequencies under the same access situation occurring during the entire connection period through analysis of a use behavior pattern of the entire connection period and detects an abnormal use behavior using the entire use behavior pattern and deviation of pattern error rate during a personalized connection period.

Additional features and advantages of the present invention will be shown in the following description, will be apparent by the following description, and will be known well through practice of the present invention. The above and other objects and merits of the present invention will be apparent from the following detailed description of the preferred embodiments of the invention in conjunction with the accompanying drawings.

Differently from the existing network-based security systems through network traffic analysis, the abnormal behavior detection system according to the present invention realized a method for detecting an abnormal behavior by patterning various behavior elements, such as time, position, connection network and a used device of an object.

Moreover, in order to enhance system security in the BYOD and smart work environment, the abnormal behavior detection system according to the present invention processes situation information into situation information of connection, use and agent and profile information and detects behaviors, such as abnormal access and use of a terminal device using the entire use behavior pattern and deviation of pattern error rate during the personalized connection period.

In order to detect an abnormal access/use behavior, the abnormal behavior detection system according to the present invention utilizes possible atypical data on a business scenario, such as a type of a used device, connection period (for instance, on-duty hours and off-hours), access location (inside the company and outside the company), and a use period of time, as a user behavior pattern, thereby enhancing system security in the BYOD and smart work environment.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exemplary view of a BYOD and smart work environment;

FIG. 2 is a block diagram of an abnormal behavior detection system according to the present invention;

FIG. 3 is a block diagram of an abnormality detection unit according to the present invention;

FIG. 4 is a flow chart showing operation of a situation information processing part according to the present invention;

FIG. 5 is a block diagram of an entire use behavior analysis part according to the present invention;

FIG. 6 is a block diagram of an entire use behavior analysis part according to the present invention;

FIG. 8A is a table of information of past behaviors for analyzing and detecting the entire use behavior pattern during a connection period;

FIG. 8B is a table of information of present situation for analyzing and detecting the entire use behavior pattern during the connection period;

FIG. 9 is an exemplary view for analyzing and detecting the entire use behavior pattern during the connection period according to the present invention;

FIG. 10 is a graph showing the present situation information, occurrence probability per past use behavior and an error rate of the probability; and

FIG. 11 is an exemplary view showing how to obtain an error value of the present entire behavior and an error value of the present individual behavior according to the present invention.

### DETAILED DESCRIPTION OF THE PREFERRED EMBODIMENT

In order to achieve the above-mentioned objects, an abnormality detection part of an abnormal behavior detection system according to the present invention is a device for analyzing a behavior frequency in the same access situation occurring during the entire connection period through use behavior pattern analysis of the entire connection period and detecting an abnormal use behavior, when a predetermined situation information is received from a situation information collection system in a BYOD (Bring Your Own Device) and smart work environment. The abnormal behavior detection system includes: an abnormal behavior analysis module which carries out ‘detection of error value variation of the entire behavior item’ and ‘detection of error value variation of an individual behavior item’ using the frequency of use behaviors during the present connection and the average of use behaviors during the past connection through the use behavior pattern analysis procedures of the entire connection period in order to analyze whether use of web service is abnormal or not; a detection demand classifying module which classifies a received detection demand message and transfers the classified message to each analysis part of the abnormal behavior analysis module; and an abnormal behavior detection module which generates information on a detection result of normality or abnormality when the analysis result of the abnormal behavior analysis module is stored and which transfers the generated information to a control system. The abnormal behavior analysis module includes an entire use behavior analysis part which obtains an accumulated average error value of the user's past entire behavior profiles and compares the accumulated average error value with the present entire behavior error value in order to carry out ‘detection of error value variation of the entire behavior’ and which obtains an accumulated average error value of the user's past individual behavior profiles and compares the accumulated average error value with an error value of the present individual behavior in order to carry out ‘detection of error value variation of individual behavior item’, so as to judge whether or not the present user's use behavior is abnormal.

Preferably, the entire use behavior analysis part includes: a use behavior inquiry part for inquiring use processing information; a first frequency analysis part for detecting frequencies of use behaviors occurring during the entire connection period from the present processing information; a profile inquiry part for inquiring past profile information of the corresponding user; a second frequency analysis part for detecting frequencies of user behaviors under the same access situation as the past; and a use behavior comparing part which obtains an accumulated average error value of the user's past entire behavior profiles and compares the accumulated average error value with the present entire behavior error value in order to carry out ‘detection of error value variation of the entire behavior item’ and which obtains an accumulated average error value of the user's past individual behavior profiles and compares the accumulated average error value with an error value of the present individual behavior in order to carry out ‘detection of error value variation of individual behavior item’, so as to judge whether or not the user's use behavior is abnormal.

Preferably, the entire use behavior analysis part includes: a use behavior inquiry part for inquiring use processing information; a first frequency analysis part for detecting frequencies of use behaviors occurring during the entire connection period from the present processing information; a profile inquiry part for inquiring past profile information of the corresponding user; a second frequency analysis part for detecting frequencies of user behaviors under the same access situation as the past; and a use behavior comparing part which obtains a cumulative average error value of the user's past entire behavior profile and compares the cumulative average error value with an error value of the present entire behavior to carry out ‘detection of variation of the entire behavior item’, and obtains a cumulative average error value of the user's past individual behavior profile and compares the cumulative average error value with an error value of the present individual behavior to carry out ‘detection of variation of the individual behavior item’, so as to judge whether or not the user's use behavior is abnormal.

Preferably, the use behavior comparing part includes: a present entire behavior error calculating part which obtains an error between the past profiles with the same access type as the present user's entire use behavior pattern, namely, an error value of the present entire behavior; an entire behavior cumulative average error calculating part which obtains a cumulative average error value of the user's past entire behavior profile in order to carry out the ‘detection of error value variation of the entire behavior’; an entire behavior error comparing part which compares a value obtained by multiplying the cumulative average error value of the entire behavior by 1.N with the error value of the present entire behavior, and which outputs a result value of normality if the value obtained through multiplication is larger than the error value of the present entire behavior; a present individual behavior error calculating part which obtains an error between the past profiles with the same access type as the present user's individual use behavior pattern, namely, an error value of the present individual behavior; an individual behavior cumulative average error calculating part which obtains a cumulative average error value of the user's past individual behavior profile in order to carry out the ‘detection of error value variation of the individual behavior item’; an individual behavior error comparing part which compares a value obtained by multiplying the cumulative average error value of the individual behavior by 1.M with the error value of the present individual behavior, and which outputs a result value of normality if the value obtained through multiplication is larger than the error value of the present individual behavior; and a normality judging part which judges the present user's use behavior as a normal behavior if all of the entire behavior error comparing part and the individual behavior error comparing part output result values of normality.

In order to achieve the above-mentioned objects of the present invention, a method for detecting abnormality of the abnormality detection part according to the present invention relates to a method for analyzing frequencies of behaviors under the same access situation occurring during the entire connection period through the use behavior pattern analysis of the entire connection period and detecting an abnormal use behavior when a predetermined situation information is received from the situation information collection system in a BYOD (Bring Your Own Device) and smart work environment.

The method for detecting abnormality includes: a process that the detection demand classifying module classifies received detection demand messages and transfers the classified messages to each analysis part of the abnormal behavior analysis module; a process that the abnormal behavior analysis module analyzes abnormality of the web service use by carrying out ‘detection of error value variation of the entire behavior item’ and ‘detection of error value variation of the individual behavior item’ using the frequency of use behaviors during the present connection and the average of use behaviors during the past connection through an analysis procedure of the use behavior pattern during the entire connection period; and a process that the abnormal behavior detection module generates information of the detection result of normality or abnormality when the analysis result of the abnormal behavior analysis module is stored and transfers the generated information to the control system. The abnormal behavior analysis module obtains a cumulative average error value of the user's past entire behavior profile and compares the cumulative average error value with an error value of the present entire behavior to carry out ‘detection of variation of the entire behavior item’, and obtains a cumulative average error value of the user's past individual behavior profile and compares the cumulative average error value with an error value of the present individual behavior to carry out ‘detection of variation of the individual behavior item’, and then, carries out an analysis procedure of the entire use behavior pattern to judge whether or not the present user's use behavior is abnormal.

Hereinafter, Reference will be now made in detail to the preferred embodiments of the present invention with reference to the attached drawings. The example embodiments which will be described later are provided to make those skilled in the art easily understand the present invention. In the drawings, similar reference numerals have similar or the same functions in various aspects.

A BYOD and smart work service can analyze situation information of a user who accesses/uses an internal service of an enterprise, judge whether or not the user's behavior is abnormal in real time, and control the corresponding user's access and use if necessary. The abnormal behavior detection system according to the present invention judges whether or not the user's behavior is abnormal based on previously accumulated normal profile or previously established security policies and the present occurring behavior.

The situation information means information related with a user's connection, use and termination which are collected in the collection system and transferred to the abnormal behavior detection system. The profile is a set of information that identifies the user and quantifies the user's behavior, and is the information that information on the user has been accumulated and patterned from the past. Profiling is a series of behaviors for profile management, such as generation, correction, deletion and storing of profiles.

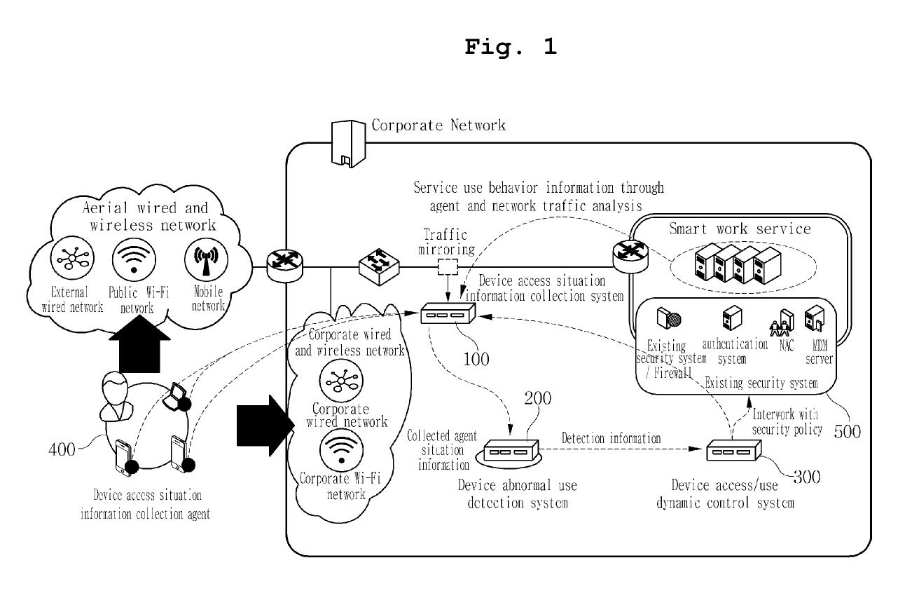

FIG. 1 is an exemplary view showing a BYOD and smart work environment.

As shown in FIG. 1, the BYOD and smart work environment is configured to have a situation information collection system 100, an abnormal behavior detection system 200, a control system 300, a personal device 400 and a security system 500, such as an MDM server or an NAC server.

The situation information collection system 100 collects relevant situation information when the personal device 400 and an MDM agent device is authorized, is accessed and terminates connection.

In this instance, collected situation information contains connection address (ID, post, authority, present status, and so on), connection pattern (authentication result, the number of authentication failures, and so on), network behavior information (connection time, position, and so on), and connection termination time information. Such situation information exits as periodic transmission data and non-periodic (real-time) transmission data, but the situation information collection system 100 regards all of the data as non-periodic transmission data and collects the data.

Next, the abnormal behavior detection system 200 includes a situation information receiving part, a situation information processing part and an abnormal behavior detection part. As shown in FIG. 1, the abnormal behavior detection system 200 carries out detection of an abnormal behavior by receiving situation information from the situation information collection system 100, and then, transfers a detected result to the control system 300, such as a dynamic access control middleware.

The abnormal behavior detection system 200 classifies the situation information received from the situation information collection system 100 by service access session, processes the situation information as occasion demands, and generates additional information, such as access ID, creation of device ID, and information on past behavior pattern. Moreover, the abnormal behavior detection system 200 patterns the accumulated data by user ID in order to generate and update profiles. Processing information of a user who accesses and uses services judges abnormality based on security policies and normal profile of the corresponding user. The detection result of the system is transferred to the control system 300 in real time.

The control system 300 receives abnormal behavior information detected in the abnormal behavior detection system 200 to control through a control GUI or establish and manage security policies, and interworks with an external security device. Such a control system 300 is connected with the abnormal behavior detection system 300 and the external security device, for instance, GENIAN and WAPPLES.

The personal device 400 is a personal mobile device, such as a smart phone, a lap-top computer and a tablet PC, and can access to IT resources inside an enterprise, such as database and applications inside the enterprise, and a user deals with business through the personal device 400.

The personal device 400 generates situation information when the personal device 400 is authorized, is accessed and terminates connection. In this instance, the situation information is the same as described above.

The security system 500 is located at a DMZ or a screened subnet and performs function as a gateway for communication, such as authentication connection between corporate network and the personal device 400, direct push update and so on. A number of agents access to the security system 500 to generate the above-mentioned situation information.

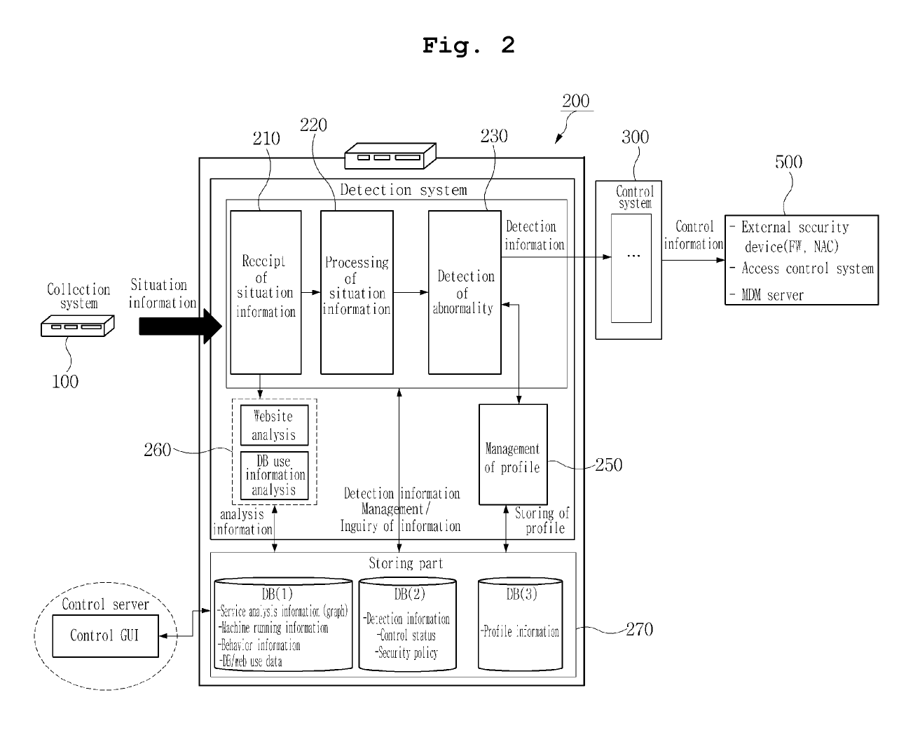

FIG. 2 is a block diagram of the abnormal behavior detection system according to the present invention.

As shown in FIG. 2, the abnormal behavior detection system 200 according to the present invention includes a situation information receiving part 210, a situation information processing part 220, an abnormality detection part 230, a profile managing part 250, an information analysis part 260, and a storing part 270.

The situation information receiving part 210 receives information on a user's various situations, such as ‘network access’, ‘service use’ and ‘termination of connection’, from the situation information collection system 100 separated physically, and transfers the received information to the situation information processing part 220 and the information analysis part 260.

All of the received situation information is transferred to the situation information processing part 220, but use situation information, such as information on web service use demand/response, information on DB SQL Batch demand/response, and information on DB RPC demand/response, is transferred to the information analysis part 260. The information analysis part 260 receives the use situation information and carries out website analysis and DB use information analysis.

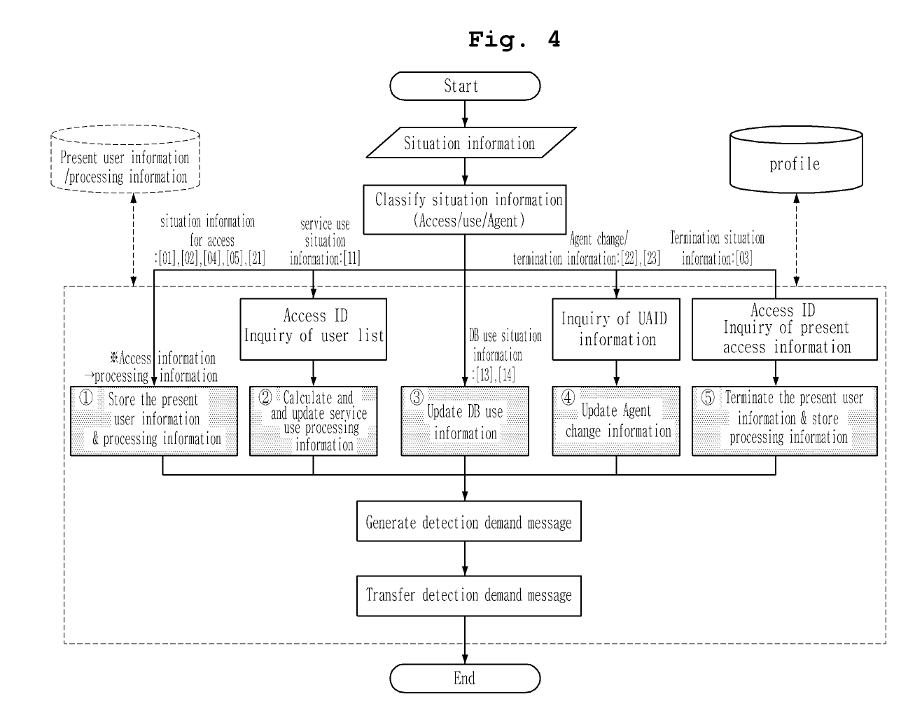

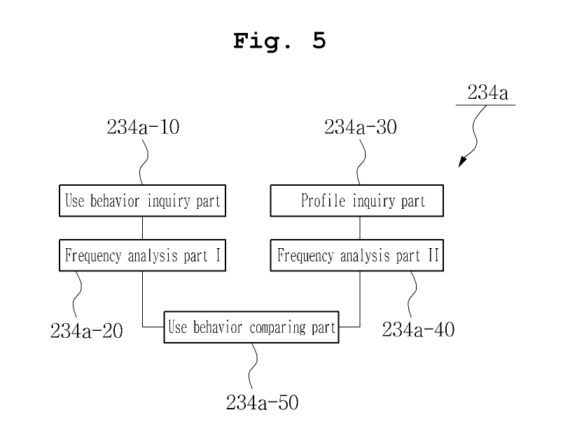

As shown in FIG. 4, the situation information processing part 220 classifies and processes the situation information data received from the situation information collection system 100, and then stores the processed data by the user's connection session.

The situation information processing part 220 receives and processes the situation information, such as ‘network connection’, ‘service use’ and ‘termination of connection’, received through the situation information receiving part 210, and then, stores the processed situation information in a temporary storage space located at one side of the storing part 270. In this instance, the temporary storage space may be in the form of a DB, a file or a memory.

The situation information processing part 220 combines and processes the situation information based on the connection ID and stores the processing information in the temporary storage space, and the detection module uses the processing information. The connection ID is combination of a connection address and a session ID.

The situation information processing part 220 adds connection information or carries out an update process according to whether or not there are authentication result and the user's connection information if situation information related with ‘network connection’ is received. As the situation information related with ‘network connection’, there are success of general authentication, failure of general authentication, intensified authentication, agent installation authentication, agent access information, and so on.

The situation information processing part 220 updates service use information based on the same connection ID when the situation information related with ‘service use’ is received.

Furthermore, when the situation information related with ‘DB use’ is received, the situation information processing part 220 updates the corresponding information to the processing information. Additionally, when the situation information related with ‘agent change’ is received, the situation information processing part 220 inquires UAID and updates the information to the user's processing information which coincides with the corresponding information. In addition, when the situation information related with ‘termination of connection’ is received, the situation information processing part 220 updates termination of the present connection ID and connection termination time.

After that, when all the situation information is received, the situation information processing part 220 generates a detection demand message and transfers the message to the abnormality detection part 230.

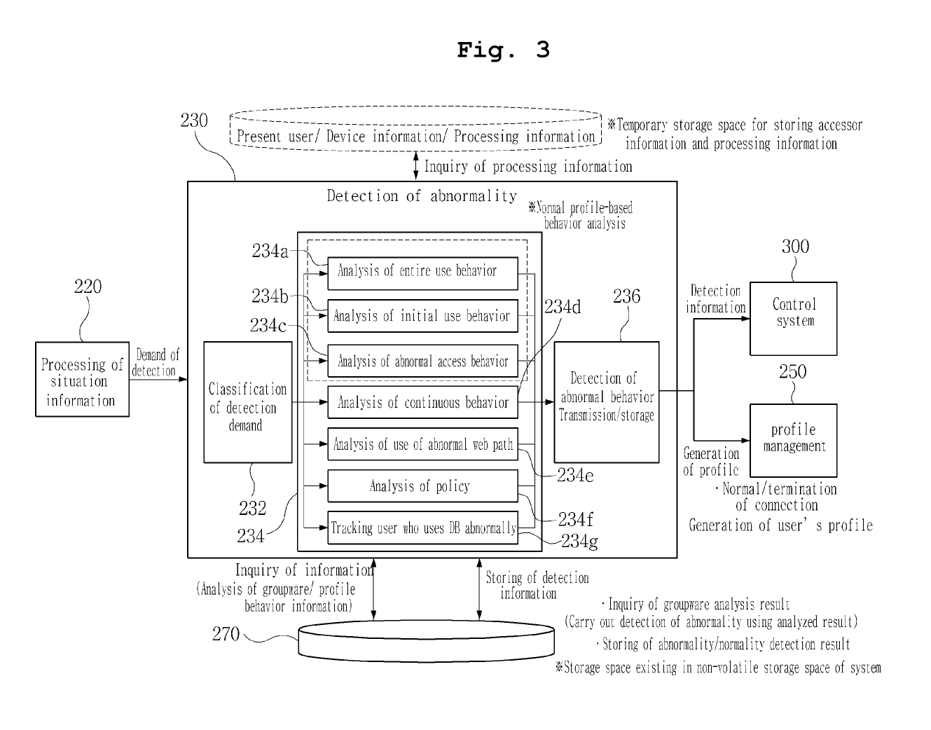

The abnormality detection part 230 is a device for classifying the detection demand message and analyzing and detecting an abnormal behavior related with the user's network use. As shown in FIG. 3, the abnormality detection part 230 includes a detection demand classifying module 232, an abnormal behavior analysis module 234, and an abnormal behavior detection module 236. FIG. 3 is a block diagram of an abnormality detection part according to the present invention.

When situation information of various kinds is inputted, the detection demand classifying module 232 classifies the detection demand message and transfers the message to analysis parts 234a to 234g of the abnormal behavior analysis module 234 to carry out analysis.

The abnormal behavior analysis module 234 is a module to analyze various abnormal behaviors, and includes normal profile-based behavior analysis parts 234a, 234b and 234c, a continuous behavior analysis part 234d, an abnormal web use analysis part 234e, a policy analysis part 234f, and a user tracking part 234g. The analysis parts 234a to 234g of the abnormal behavior analysis module 234 carry out different analyses of information according to kinds of the situation information inputted.

The normal profile-based behavior analysis parts 234a, 234b and 234c compare the entire use behavior, the initial use behavior and abnormal access behavior during the connection period with analysis values of the past normal profile information, and then, analyze different points between abnormal behaviors and normal behaviors.

The continuous behavior analysis part 234d analyzes whether the use situation information continuously inputted from the present connection session repeatedly carries out the same behavior.

The abnormal web use analysis part 234e compares the user's previous service use page with an URI of the present input use situation information through the structure of the previously analyzed service web site, and then, analyzes an abnormal behavior inaccessible by the user's behavior.

The policy analysis part 234f judges whether the processing information and profile of the user, who is in connection and use, is abnormal or not. The policy analysis part 234f judges normality and abnormality on the basis of the previously established security policy as judging criteria.

The security policy established by an administrator includes a series of conditions (criteria) and control results applied when the conditions are accorded. The security policy of a system to be developed is established using kinds of information which is used for forming the user's processing information and profile information.

The user tracking part 234g tracks a user, who a may make an abnormal behavior, using DB-query generation information which has been previously made when an abnormal behavior is detected by the security policy in which DB use situation information is set.

When an analysis value of the behavior is stored from the abnormal behavior analysis module 234, the abnormal behavior detection module 236 judges whether the analysis value of the behavior is abnormal or not, generates detection information, and transfers the detection information to the control system 300. If an abnormal behavior is not detected when situation information of user connection determination is inputted, the abnormal behavior detection module 236 sends a profile generation message to the profile managing part 250. Moreover, the profile managing part 250 generates profile of normal/connection termination.

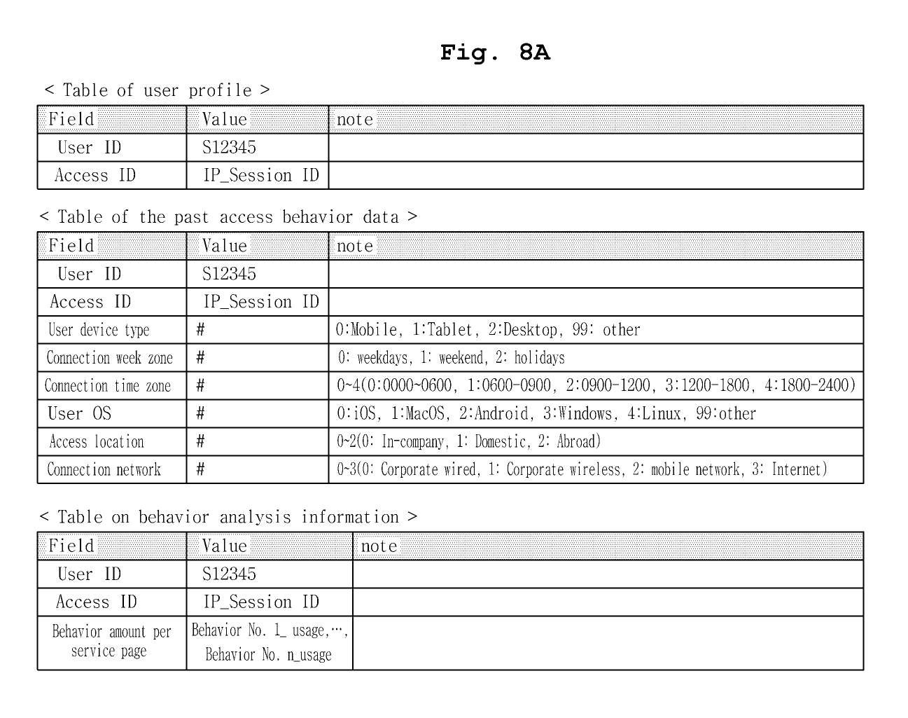

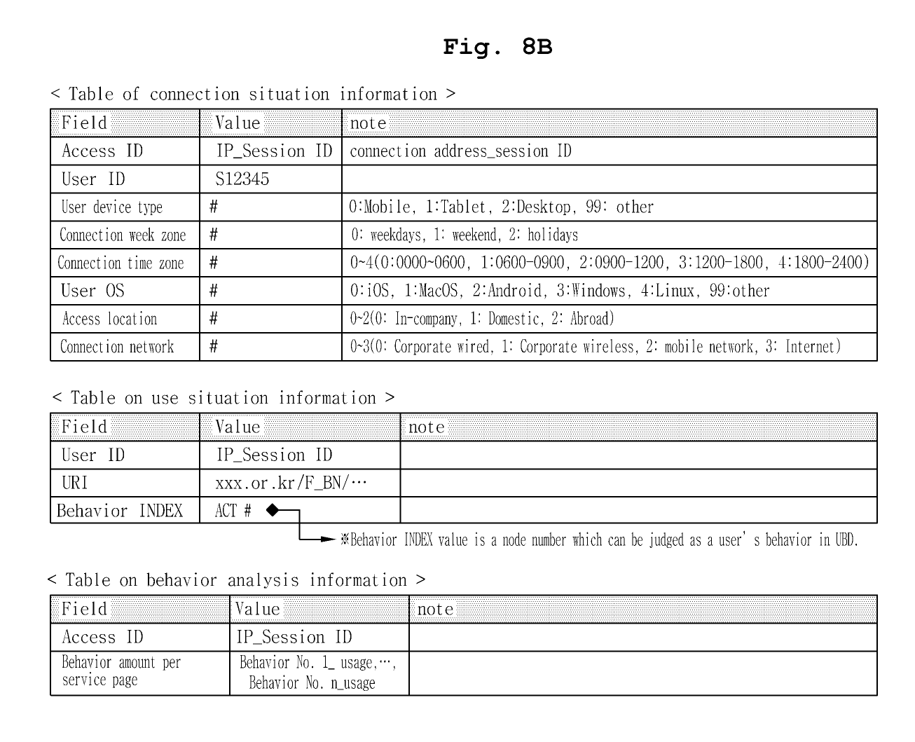

As shown in FIG. 8A, the profile managing part 250 generates profile information by profiling the situation information of various use behaviors of the user, and then, stores and manages the profile information.

When the situation information receiving part 210 receives the user's information of various situations, such as ‘network connection’, ‘service use’, ‘termination of connection’ and so on, the information analysis part 260 analyzes web site and DB use information through the received situation information.

Next, the storing part 270 stores the information, which is processed into connection, use and agent situation information, and the profile information. The situation information collected by the situation information collection system 100 is processed into connection, use and agent situation information, and the situation information at the time of termination of connection is processed into profile information, and then, is stored in the storing part 270.

In this instance, the stored profile information includes user profile, terminal device profile, access behavior profile, and use behavior. The user profile contains user authority information, the number of total authentication failures, the recent access date, the initial access date, total service hours and the number of times of access, the terminal device profile contains ID, type, OS, browser, name, MAC, whether or not an agent is installed, whether or not a screen is locked, installation program information, automatic login setting, and the recent access date. Furthermore, the access behavior profile contains access behavior pattern information.

FIG. 4 is a flow chart showing operation of a situation information processing part according to the present invention.

As shown in FIG. 4, the situation information processing part 220 according to the present invention classifies the situation information by code, processes the situation information, and stores the processing information in the temporary storage space. The situation information inputted through the situation information receiving part 210 is classified by each situation information because having different types, and is stored on the basis of information which can identify the user, such as access ID, user ID, UAID and so on.

In case of the situation information of ‘access’, the situation information processing part 220 creates new access if the present access information does not exist, but the corresponding information is updated if there is information on the existing access.

In case of the situation information of ‘service use’, the situation information processing part 220 finds the session, which is in connection, on the basis of the access ID, updates service use information, and calculates relevant behavior analysis information.

Additionally, in case of the situation information of ‘DB use’, the situation information processing part 220 continuously stores the situation information in the storage space until the corresponding information is utilized, and deletes an old list above a predetermined period.

In addition, in case of the situation information of ‘agent change/termination’, the situation information processing part 220 searches a user who has the corresponding UAID and updates change information.

Moreover, in case of the situation information of ‘termination’, the situation information processing part 220 terminates connection of the corresponding access ID and updates processing information.

FIG. 5 is a block diagram of the entire use behavior analysis part according to the present invention.

The normal profile-based behavior analysis parts 234a, 234b and 234c includes an entire use behavior analysis part 234a, an initial use behavior analysis part 234b, and an abnormal access behavior analysis part 234c. The behavior analysis parts 234a, 234b and 234c compare a pattern of the use behavior of the entire connection period, a pattern of the initial use behavior and a pattern of the abnormal access behavior with an analysis value of the past normal profile information and analyze different points with the normal behavior.

The entire use behavior analysis part 234a out of the normal profile-based behavior analysis parts 234a, 234b and 234c is a device for carrying out a pattern analysis of the use behavior of the entire connection period, and includes a use behavior inquiry part 234a-10, a first frequency analysis part 234a-20, a profile inquiry part 234a-30, a second frequency analysis part 234a-40 and a use behavior comparing part 234a-50 as shown in FIG. 5.

When a detection demand message is received from the situation information processing part 220, the profile inquiry part 234a-30 inquires the corresponding user's past profile information. Moreover, the second frequency analysis part 234a-detects the frequency of the user behavior in the same connection situation as the past.

The use behavior inquiry part 234a-10 inquires the present user's use processing information.

The first frequency analysis part 234a-20 detects frequency of use behaviors occurring during the entire connection period.

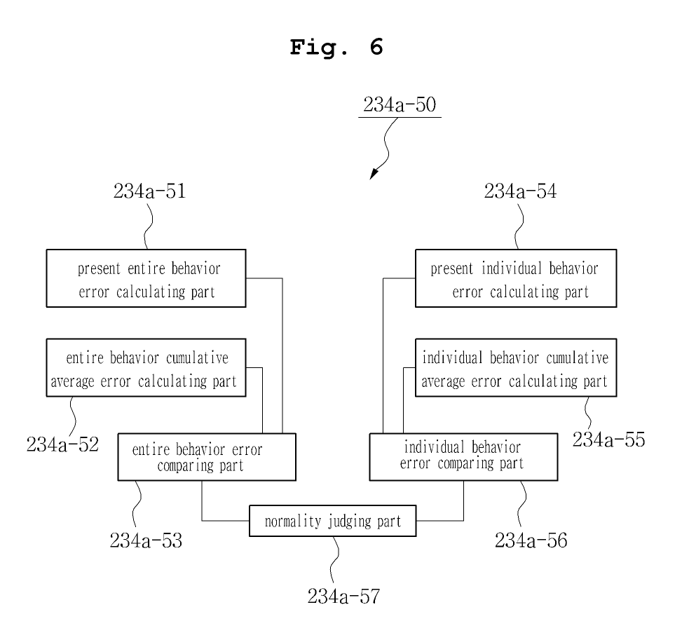

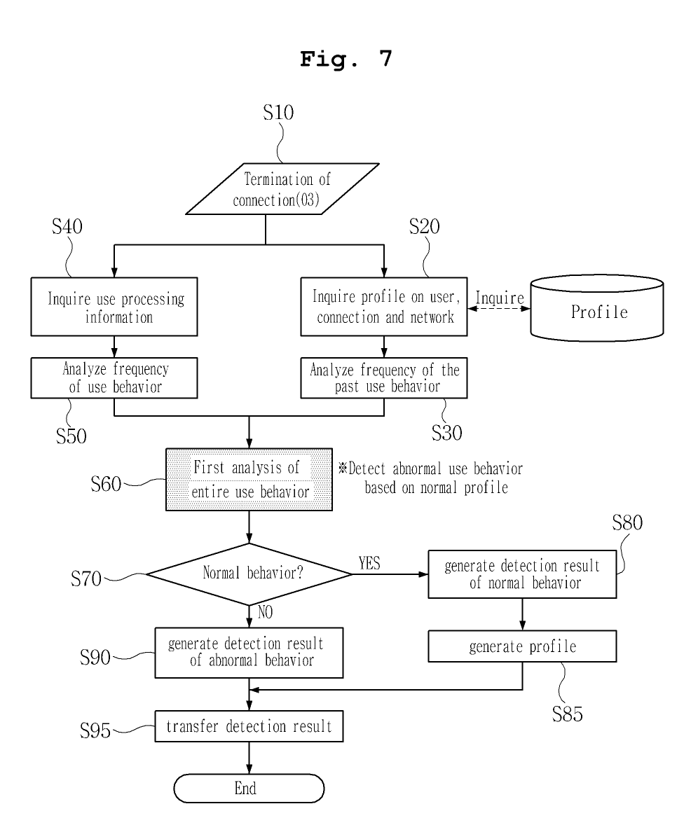

As shown in FIG. 6, the use behavior comparing part 234a-50 includes a present entire behavior error calculating part 234a-51, an entire behavior cumulative average error calculating part 234a-52, an entire behavior error comparing part 234a-53, a present individual behavior error calculating part 234a-54, an individual behavior cumulative average error calculating part 234a-55, an individual behavior error comparing part 234a-56 and a normality judging part 234a-57. The use behavior comparing part 234a-50 obtains a cumulative average error value of the user's past entire behavior profile and compares the cumulative average error value with an error value of the present entire behavior to carry out ‘detection of variation of the entire behavior item’. Additionally, the use behavior comparing part 234a-50 obtains a cumulative average error value of the user's past individual behavior profile and compares the cumulative average error value with an error value of the present individual behavior to carry out ‘detection of variation of the individual behavior item’, so as to judge whether or not the user's use behavior is abnormal. FIG. 6 is a block diagram of the entire use behavior analysis part according to the present invention.

The present entire behavior error calculating part 234a-51 obtains an error between the past profiles with the same access type as the present user's entire use behavior pattern, namely, an error value of the present entire behavior by calculating as shown in the following Equation 1.

$$[ Equation 1 ]$$

$$\frac{\sqrt{{( \begin{matrix}present \#1 occurrence rate - \\ past \#1 cumulative occurrence rate\end{matrix} )}^{2} + … + {( \begin{matrix}present \# n occurrence rate - \\ past \# n cumulative occurrence rate\end{matrix} )}^{2}}}{( Number of behaviors )}$$

Here, the pastifn cumulative occurrence rate is total occurrence rate of Ifn behavior out of the total behaviors of the entire past profiles. If there is no past behavior information, it is calculated as ‘0’.

The entire behavior cumulative average error calculating part 234a-52 calculates as the following Equation 2 to obtain a cumulative average error value of the user's past entire behavior profiles so as to carry out ‘detection of error value variation of the entire behavior’.

Cumulative average error value of the entire behavior=[(error value between profile 1 and profile 2)+{error value between (profile 1 behavior amount+2 behavior amount) and profile 3}+ . . . +)+{error value between (profile 1 behavior amount+ . . . +profilen-2 behavior amount) and profilen-1}]/(n−2) [Equation 2]

Here, n−2 is the number of profiles.

The entire behavior error comparing part 234a-53 compares a value obtained by multiplying the cumulative average error value of the entire behavior by 1.N with the error value of the present entire behavior, and outputs a result value of normality if the value obtained through multiplication (cumulative average error value×1.N) is larger than the error value of the present entire behavior. A default value of N is set to 20.

The present individual behavior error calculating part 234a-54 obtains an error between the past profiles with the same access type as the present user's individual use behavior pattern, namely, an error value of the present individual behavior, by calculating as the following Equation 3.

$$[ Equation 3 ]$$

$$\sqrt{{( present \# n occurrence rate - past \# n cumulative occurrence rate )}^{2}}$$

Here, the past#n cumulative occurrence rate is total occurrence rate of #n behavior out of the total behaviors of the entire past profiles.

[99] The individual behavior cumulative average error calculating part 234a-55 obtains a cumulative average error value of the user's past individual behavior profile in order to carry out the ‘detection of error value variation of the individual behavior item’ by calculating as the following Equation 4.

Cumulative average error value of individual behavior=[(error value between profile 1#x and profile 2#x)+{error value between 1#x of (profile 1 behavior amount+2 behavior amount) and profile 3#x}+ . . . +)+{error value between #x of (profile 1 behavior amount+ . . . +profilen-2 behavior amount) and profilen-1#x}]/(n−2) [Equation 4]

Here, n−2 is the number of profiles.

The individual behavior error comparing part 234a-56 compares a value obtained by multiplying the cumulative average error value of the individual behavior by 1.M with the error value of the present individual behavior, and which outputs a result value of normality if the value obtained through multiplication (cumulative average error value×1.M) is larger than the error value of the present individual behavior. The default value of M is set to 30.

The normality judging part 234a-57 judges the present user's use behavior as a normal behavior if all of the entire behavior error comparing part 234a-53 and the individual behavior error comparing part 234a-56 output result values of normality. If any one of the entire behavior error comparing part 234a-53 and the individual behavior error comparing part 234a-56 outputs a result value of abnormality, the normality judging part 234a-57 judges the present user's use behavior as an abnormal behavior.

FIG. 7 is a flow chart showing operation of the abnormality detection part according to the present invention. Especially, the abnormality detection part relates to analysis of the pattern of the entire use behavior during the connection period by the normal profile-based behavior analysis part.

The abnormality detection part 230 according to the present invention is a device which classifies the detection demand message and analyzes and detects an abnormal behavior related with the user's network use, and includes a detection demand classifying module 232, an abnormal behavior analysis module 234, and an abnormal behavior detection module 236.

Out of them, the abnormal behavior analysis module 234 is a module for analyzing patterns of various abnormal behaviors, and includes a continuous behavior analysis part 234d, an abnormal web use analysis part 234e, a policy analysis part 234f, and a user tracking part 234g.

The normal profile-based behavior analysis parts 234a, 234b and 234c compare the pattern of the entire use behavior, the pattern of the initial use behavior and the pattern of the abnormal access behavior with analysis values of the normal profile information, and then, analyze different points between abnormal behaviors and normal behaviors. FIG. 8A shows a table of profiles for analyzing and detecting the entire use behavior pattern during the connection period, namely, information of the past behaviors, and FIG. 8B shows a table of information of present situation for analyzing and detecting the entire use behavior pattern during the connection period.

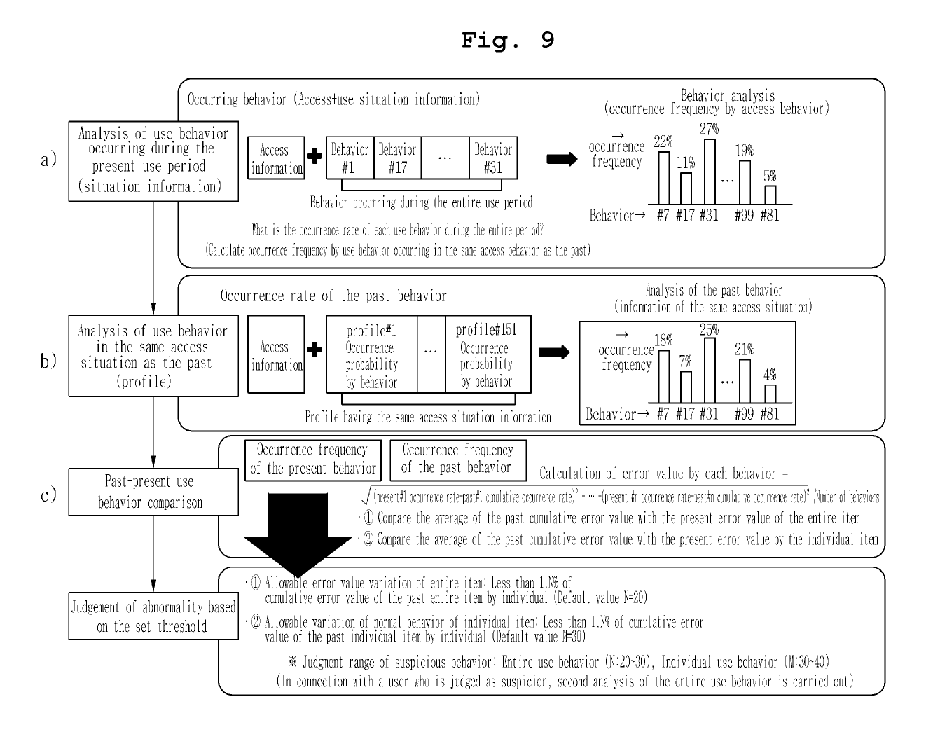

When the situation information of ‘termination (connection termination)’ is inputted to the abnormal behavior detection system 200 and a detection demand message is received from the situation information processing part 220, as shown in b) of FIG. 9, the entire use behavior analysis part 234a inquires the corresponding user's past profile information to analyze the frequency of behaviors in the same access situation (S10 to S30). FIG. 9 is an exemplary view for analyzing and detecting the pattern of the entire use behavior during the connection period according to the present invention.

Additionally, as shown in a) of FIG. 9, the entire use behavior analysis part 234a inquires use processing information, and then, analyzes the frequency of the use behaviors during the entire connection period in the present processing information (S40 to S50).

After that, as shown in c) of FIG. 9, the entire use behavior analysis part 234a carries out ‘detection of error value variation of the entire behavior item’ and ‘detection of error value variation of an individual behavior item’ using the frequency of use behaviors during the present connection and the average of use behaviors during the past connection to judge an abnormal behavior (S60).

The entire use behavior analysis part 234a obtains an error between the past profiles with the same access type as the present user's entire use behavior pattern, namely, an error value of the present entire behavior by calculating as shown in the following Equation 1.

$$[ Equation 1 ]$$

$$\frac{\sqrt{{( \begin{matrix}present \#1 occurrence rate - \\ past \#1 cumulative occurrence rate\end{matrix} )}^{2} + … + {( \begin{matrix}present \# n occurrence rate - \\ past \# n cumulative occurrence rate\end{matrix} )}^{2}}}{( Number of behaviors )}$$

Here, the pastifn cumulative occurrence rate is total occurrence rate of Ifn behavior out of the total behaviors of the entire past profiles. If there is no past behavior information, it is calculated as ‘0’.

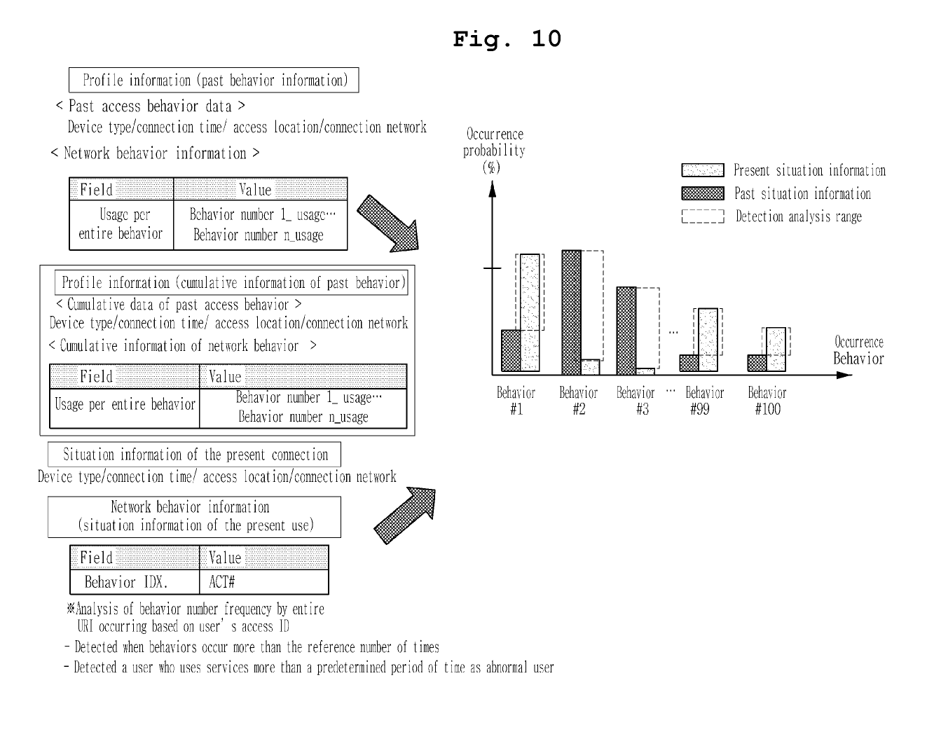

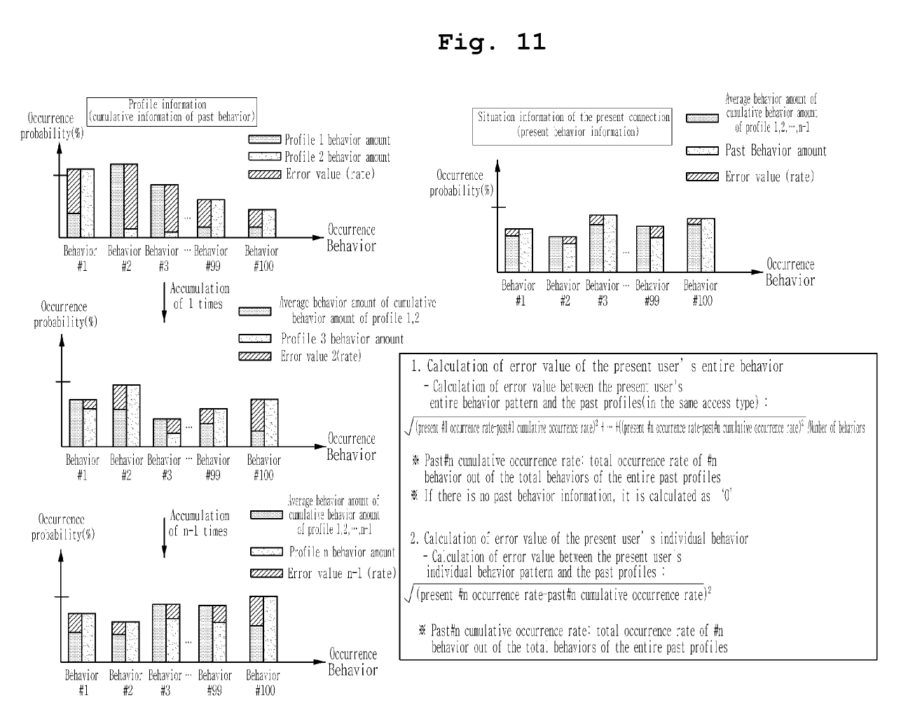

Moreover, the entire use behavior analysis part 234a calculates as the following Equation 2 to obtain a cumulative average error value of the user's past entire behavior profiles. FIG. 10 is a graph showing the present situation information, occurrence probability per past use behavior and an error rate of the probability.

Cumulative average error value of the entire behavior=[(error value between profile 1 and profile 2)+{error value between (profile 1 behavior amount+2 behavior amount) and profile 3}+ . . . +)+{error value between (profile 1 behavior amount+ . . . +profilen-2 behavior amount) and profilen-1}]/(n−2) [Equation 2]

Here, n−2 is the number of profiles.

Through the equations, when all of the error value of the present entire behavior and the cumulative average error value of the present behavior are all obtained, the cumulative average error value of the entire behavior is multiplied by 1.N, and then, the obtained value is compared with the error value of the present entire behavior.

If the value obtained through the multiplication (cumulative average error value×1.N) is larger than the error value of the present entire behavior, the entire use behavior analysis part 234a judges the present user's use behavior as a normal behavior.

On the contrary, If the value obtained through the multiplication (cumulative average error value×1.N) is equal to or smaller than the error value of the present entire behavior, the entire use behavior analysis part 234a judges the present user's use behavior as an abnormal behavior. In this instance, the default value of N is set to 20.

On the other hand, in order to carry out ‘detection of error value variation of individual behavior item’, the entire use behavior analysis part 234a obtains an error between the past profiles with the same access type as the present user's individual use behavior pattern, namely, an error value of the present individual behavior, by calculating as the following

$$\sqrt{\begin{matrix}( present \# n occurence rate - \\ {past \# n cumulative occurence rate )}^{2}\end{matrix}} \qquad [ Equation 3 ]$$

Here, the pastifn cumulative occurrence rate is total occurrence rate of Ifn behavior out of the total behaviors of the entire past profiles.

The entire use behavior analysis part 234a obtains a cumulative average error value of the user's past individual behavior profile by calculating as the following Equation 4.

Cumulative average error value of individual behavior=[(error value between profile 1#x and profile 2#x)+{error value between #x of (profile 1 behavior amount+2 behavior amount) and profile 3#x}+ . . . +)+{error value between #x of (profile 1 behavior amount+ . . . +profilen-2 behavior amount) and profilen-1#x}]/(n−2) [Equation 4]

Here, n−2 is the number of profiles.

Through the equations 3 and 4, when all of the error value of the present individual behavior and the cumulative average error value of the individual behavior are all obtained, the cumulative average error value of the individual behavior is multiplied by 1.M, and then, the obtained value is compared with the error value of the present individual behavior.

If the value obtained through the multiplication (cumulative average error value×1.M) is larger than the error value of the present individual behavior, the entire use behavior analysis part 234a judges the present user's use behavior as a normal behavior.

On the contrary, If the value obtained through the multiplication (cumulative average error value×1.M) is equal to or smaller than the error value of the present individual behavior, the entire use behavior analysis part 234a judges the present user's use behavior as an abnormal behavior. In this instance, the default value of M is set to 30.

After carrying out the procedure for ‘detection of error value variation of the entire behavior and the procedure for ‘detection of error value variation of individual behavior item’, when all of the two procedures show the result of a normal behavior, the abnormal behavior detection system according to the present invention finally determines the present user's use behavior as a normal behavior.

If one of the two procedures shows the result of an abnormal behavior, the entire use behavior analysis part 234a judges the present user's use behavior as an abnormal behavior.

If the judgement result, for instance, normality or abnormality, of the entire use behavior analysis part 234a is stored, the abnormal behavior detection module 236 generates information of the detection result of normality or abnormality, and then, transfers the information to the control system 240.

If the result (analysis result) of the judgment (S60) is determined as a normal behavior, the abnormal behavior detection module 236 generates a detection result of a normal behavior, and then, generates the corresponding profile (S70 to S85).

If the result (analysis result) of the judgment (S60) is determined as an abnormal behavior, the abnormal behavior detection module 236 generates a detection result of an abnormal behavior (S90), and then, transfers the generated detection result, for instance, normal behavior or abnormal behavior, to the control system 300 (S95). The generated profile information is transferred to the profile managing part 250.

The abnormal behavior detection system 200 according to the present invention may be implemented in a recording medium which is readable by a computer using software, hardware or combination of the software and the hardware.

In order to implement the abnormal behavior detection system 200 into a hardware type, the abnormal behavior detection system 200 may be implemented using at least one of ASICs (Application Specific Integrated Circuits), DSPs (Digital Signal Processors), DSPDs (Digital Signal Processing Devices), PLDs (Programmable Logic Devices), FPGAs (Field Programmable Gate

Arrays), processors, controllers, micro-controllers, microprocessors and electrical parts for performing functions. As occasion demands, the abnormal behavior detection system 200 according to the present invention may be implemented by itself.

While the present invention has been particularly shown and described with reference to the example embodiments thereof, it will be understood by those of ordinary skill in the art that the above embodiments of the present invention are all exemplified and various changes and equivalences may be made therein and that all or some of the example embodiments may be combined selectively. Therefore, it would be understood that the technical and protective scope of the present invention shall be defined by the technical idea as defined by the following claims and the equivalences.

As described above, differently from the existing network-based security equipment using network traffic analysis, the abnormal behavior detection system according to the present invention patterns behaviors based on various behavior elements of an object, such as time, location, connection network, used devices and so on in order to detect an abnormal behavior.

In order to enhance system security in the BYOD and smart work environment, the abnormal behavior detection system according to the present invention carries out the first analysis, which process situation information into connection, use and agent situation information and profile information and analyzes the entire use behavior pattern during the personalized connection period, and the second analysis based on service access speed to enhance capability for detecting an abnormal behavior.

In order to detect an abnormal access/use behavior, the abnormal behavior detection system according to the present invention utilizes possible atypical data on a business scenario, such as a type of a used device, connection period (for instance, on-duty hours and off-hours), access location (inside the company and outside the company), and a use period of time, as a user behavior pattern, thereby enhancing system security in the BYOD and smart work environment.

What is claimed is:

1. An abnormality detection part of an abnormal behavior detection system which analyzes the frequency of behaviors in the same connection situation occurring during the entire connection period through pattern analysis of use behaviors of the entire connection period in order to detect an abnormal behavior when predetermined situation information is received from a situation information collection system in a BYOD (Bring Your Own Device) and smart work environment, the abnormality detection part comprising:
an abnormal behavior analysis module which carries out ‘detection of error value variation of the entire behavior item’ and ‘detection of error value variation of an individual behavior item’ using the frequency of use behaviors during the present connection and the average of use behaviors during the past connection through the use behavior pattern analysis procedures of the entire connection period in order to analyze whether use of web service is abnormal or not;
a detection demand classifying module which classifies received detection demand messages and transfers the classified messages to each analysis part of the abnormal behavior analysis module; and
an abnormal behavior detection module which generates information on a detection result of normality or abnormality when the analysis result of the abnormal behavior analysis module is stored and which transfers the generated information to a control system,
wherein the abnormal behavior analysis module obtains a cumulative average error value of the user's past entire behavior profile and compares the cumulative average error value with an error value of the present entire behavior to carry out ‘detection of error value variation of the entire behavior item’, and obtains a cumulative average error value of the user's past individual behavior profile and compares the cumulative average error value with an error value of the present individual behavior to carry out ‘detection of error value variation of the individual behavior item’, so as to judge whether or not the user's use behavior is abnormal.

2. The abnormality detection part according to claim 1, wherein the entire use behavior analysis part includes:
a use behavior inquiry part for inquiring use processing information;
a first frequency analysis part for detecting the frequency of use behaviors occurring during the entire connection period from the present processing information;
a profile inquiry part for inquiring the corresponding user's past profile information;
a second frequency analysis part for detecting the frequency of the user's behaviors in the same connection situation as the past; and
a use behavior comparing part which obtains a cumulative average error value of the user's past entire behavior profile and compares the cumulative average error value with an error value of the present entire behavior to carry out ‘detection of variation of the entire behavior item’, and obtains a cumulative average error value of the user's past individual behavior profile and compares the cumulative average error value with an error value of the present individual behavior to carry out ‘detection of variation of the individual behavior item’, so as to judge whether or not the user's use behavior is abnormal.

3. The abnormality detection part according to claim 2, wherein the use behavior comparing part includes:
a present entire behavior error calculating part which obtains an error between the past profiles with the same access type as the present user's entire use behavior pattern, namely, an error value of the present entire behavior;
an entire behavior cumulative average error calculating part which obtains a cumulative average error value of the user's past entire behavior profiles so as to carry out ‘detection of error value variation of the entire behavior’;
an entire behavior error comparing part which compares a value obtained by multiplying the cumulative average error value of the entire behavior by 1.N with the error value of the present entire behavior, and outputs a result value of normality if the value obtained through multiplication is larger than the error value of the present entire behavior;
a present individual behavior error calculating part which obtains an error between the past profiles with the same access type as the present user's individual use behavior pattern, namely, an error value of the present individual behavior;
an individual behavior cumulative average error calculating part which obtains a cumulative average error value of the user's past individual behavior profile in order to carry out the ‘detection of error value variation of the individual behavior item’;
an individual behavior error comparing part which compares a value obtained by multiplying the cumulative average error value of the individual behavior by 1.M with the error value of the present individual behavior, and which outputs a result value of normality if the value obtained through multiplication is larger than the error value of the present individual behavior; and
a normality judging part which judges the present user's use behavior as a normal behavior if all of the entire behavior error comparing part and the individual behavior error comparing part output result values of normality.

4. The abnormality detection part according to claim 3, wherein the present entire behavior error calculating part obtains an error value of the present entire behavior by calculating as shown in the following Equation:
$$\frac{\sqrt{{( \begin{matrix}present \#1 occurrence rate - \\ past \#1 cumulative occurrence rate\end{matrix} )}^{2} + … + {( \begin{matrix}present \# n occurrence rate - \\ past \# n cumulative occurrence rate\end{matrix} )}^{2}}}{( Number of behaviors )}$$
wherein the pastifn cumulative occurrence rate is total occurrence rate of Ifn behavior out of the total behaviors of the entire past profiles, and is calculated as ‘0’ if there is no past behavior information.

5. The abnormality detection part according to claim 3, wherein the present individual behavior error calculating part obtains an error value of the present individual behavior by calculating as the following Equation:
$$\sqrt{{( present \# n occurrence rate - past \# n cumulative occurrence rate )}^{2}}$$
wherein the pastifn cumulative occurrence rate is total occurrence rate of Ifn behavior out of the total behaviors of the entire past profiles.

6. The abnormality detection part according to claim 3, wherein the entire behavior cumulative average error calculating part obtains a cumulative average error value of the user's past entire behavior profiles by calculating as shown in the following equation:
Cumulative average error value of the entire behavior=[(error value between profile 1 and profile 2)+{error value between (profile 1 behavior amount+2 behavior amount) and profile 3}+ . . . +)+{error value between (profile 1 behavior amount+ . . . +profilen-2 behavior amount) and profilen-1}]/(n−2),
wherein n−2 is the number of profiles.

7. The abnormality detection part according to claim 3, wherein the individual behavior cumulative average error calculating part obtains a cumulative average error value of the user's past individual behavior profile by calculating as the following Equation:
Cumulative average error value of individual behavior=[(error value between profile 1#x and profile 2#x)+{error value between #x of (profile 1 behavior amount+2 behavior amount) and profile 3#x}+ . . . +)+{error value between #x of (profile 1 behavior amount+ . . . +profilen-2 behavior amount) and profilen-1#x}]/(n−2),
wherein n−2 is the number of profiles.

8. The abnormality detection part according to claim 3, wherein the use behavior comparing part sets 20 as the default value of N and 30 as the default value of M to compare the error values.

9. An abnormal behavior detection method of an abnormal behavior detection part which analyzes the frequency of behaviors in the same connection situation occurring during the entire connection period through pattern analysis of use behaviors of the entire connection period in order to detect an abnormal behavior when predetermined situation information is received from a situation information collection system in a BYOD (Bring Your Own Device) and smart work environment, the abnormal behavior detection method comprising:
a process that a detection demand classifying module classifies received detection demand messages and transfers the classified messages to each analysis part of an abnormal behavior analysis module;
a process that the abnormal behavior analysis module carries out ‘detection of variation of the entire behavior item’ and ‘detection of variation of an individual behavior item’ using the frequency of use behaviors during the present connection and the average of use behaviors during the past connection through the first analysis of the entire use behaviors for analyzing a pattern of use behaviors of the entire connection period, so as to analyze whether use of web service is abnormal or not; and
a process that an abnormal behavior detection module generates information on a detection result of normality or abnormality when the analysis result of the abnormal behavior analysis module is stored and transfers the generated information to a control system,
wherein the abnormal behavior analysis module carries out an analysis procedure of the entire use behavior pattern for judging whether or not the user's use behavior is abnormal in such a way as to obtain a cumulative average error value of the user's past entire behavior profile and compare the cumulative average error value with an error value of the present entire behavior to carry out ‘detection of error value variation of the entire behavior item’ and in such a way as to obtain a cumulative average error value of the user's past individual behavior profile and compare the cumulative average error value with an error value of the present individual behavior to carry out ‘detection of error value variation of the individual behavior item’.

10. The abnormal behavior detection method according to claim 9, wherein the analysis procedure of the entire use behavior pattern includes:
a process that a use behavior inquiry part inquires use processing information;
a process that a first frequency analysis part detects the frequency of use behaviors occurring during the entire connection period from the present processing information;
a process that a profile inquiry part inquires the corresponding user's past profile information;
a process that a second frequency analysis part detects the frequency of the user's behaviors in the same connection situation as the past; and
a process that a use behavior comparing part calculates an error value by each behavior and judges whether or not the present user's use behavior is abnormal according to the calculated error value in order to carry out the ‘variation detection of the entire behavior item’, and judges whether or not the present user's use behavior is abnormal using the variation by individual behavior item in order to carry out the ‘variation detection of individual behavior item’.

11. The abnormal behavior detection method according to claim 10, wherein the process of judging whether or not the user's use behavior is abnormal includes:
a process that a present entire behavior error calculating part obtains an error between the past profiles with the same access type as the present user's entire use behavior pattern, namely, an error value of the present entire behavior;
a process that an entire behavior cumulative average error calculating part obtains a cumulative average error value of the user's past entire behavior profiles so as to carry out ‘detection of error value variation of the entire behavior’;
a process that an entire behavior error comparing part compares a value obtained by multiplying the cumulative average error value of the entire behavior by 1.N with the error value of the present entire behavior, and outputs a result value of normality if the value obtained through multiplication is larger than the error value of the present entire behavior;
a process that a present individual behavior error calculating part obtains an error between the past profiles with the same access type as the present user's individual use behavior pattern, namely, an error value of the present individual behavior;
a process that an individual behavior cumulative average error calculating part obtains a cumulative average error value of the user's past individual behavior profile in order to carry out the ‘detection of error value variation of the individual behavior item’;
a process that an individual behavior error comparing part compares a value obtained by multiplying the cumulative average error value of the individual behavior by 1.M with the error value of the present individual behavior, and outputs a result value of normality if the value obtained through multiplication is larger than the error value of the present individual behavior; and
a process that a normality judging part judges the present user's use behavior as a normal behavior if all of the entire behavior error comparing part and the individual behavior error comparing part output result values of normality.

12. The abnormal behavior detection method according to claim 11, wherein the error value of the present entire behavior is obtained according to the following Equation:
$$\frac{\sqrt{{( \begin{matrix}present \#1 occurrence rate - \\ past \#1 cumulative occurrence rate\end{matrix} )}^{2} + … + {( \begin{matrix}present \# n occurrence rate - \\ past \# n cumulative occurrence rate\end{matrix} )}^{2}}}{( Number of behaviors )}$$
wherein the pastifn cumulative occurrence rate is total occurrence rate of Ifn behavior out of the total behaviors of the entire past profiles, and is calculated as ‘0’ if there is no past behavior information.

13. The abnormal behavior detection method according to claim 11, wherein the error value of the present individual behavior is obtained according to the following Equation:
$$\sqrt{{( present \# n occurrence rate - past \# n cumulative occurrence rate )}^{2}}$$
wherein the pastifn cumulative occurrence rate is total occurrence rate of Ifn behavior out of the total behaviors of the entire past profiles.

14. The abnormal behavior detection method according to claim 11, wherein the cumulative average error value of the entire behavior is obtained according to the following equation:
Cumulative average error value of the entire behavior=[(error value between profile 1 and profile 2)+{error value between (profile 1 behavior amount+2 behavior amount) and profile 3}+ . . . +)+{error value between (profile 1 behavior amount+ . . . +profilen-2 behavior amount) and profilen-1}]/(n−2),
wherein n−2 is the number of profiles.

15. The abnormal behavior detection method according to claim 11, wherein the cumulative average error value of the individual behavior is obtained according to the following Equation:
Cumulative average error value of individual behavior=[(error value between profile 1#x and profile 2#x)+{error value between #x of (profile 1 behavior amount+2 behavior amount) and profile 3#x}+ . . . +)+{error value between #x of (profile 1 behavior amount+ . . . +profilen-2 behavior amount) and profilen-1#x}]/(n−2),
wherein n−2 is the number of profiles.

16. The abnormal behavior detection method according to claim 11, wherein in the process of judging whether or not the user's use behavior is abnormal, the default value of N is set to 20 and the default value of M is set to 30 to compare the error values.
